(19) United States
(12) Patent Application Publication
(10) Pub. No.: US 2011/0209040 A1
(43) Pub. Date: Aug. 25, 2011

(54) EXPLICIT AND NON-EXPLICIT LINKS IN DOCUMENT

(75) Inventors: Hatem I. Zeine, Redmond, WA (US); Meir Shmouely, Kirkland, WA (US)

(73) Assignee: MICROSOFT CORPORATION, Redmond, WA (US)

(21) Appl. No.: 12/712,120

(22) Filed: Feb. 24, 2010

(51) Int. Cl. G06F 3/14; G06F 3/048

(52) U.S. Cl. 715/207; 715/862; 715/205

(57) ABSTRACT

Links may be added to a document in such a way that the links are displayed in response to a user behavior. In one example, a document has both explicit and non-explicit links. Explicit links may be highlighted by a browser at the time the page is rendered, while non-explicit links may be highlighted in response to a user's behavior, such as hovering over a linked word or phrase for some number of seconds. In one example, the non-explicit links may be included in the document through a script. The script may detect the user behavior that causes the non-explicit links to be activated, and may also identify the specific Uniform Resource Locators (URLs) to which the non-explicit links point. The addition of non-explicit links may help a user do further research on topics that arise in a document.

### BACKGROUND

When people read documents on the Internet, they often jump from topic to topic. A person might read about a person, a place, a scientific theory, a political development, etc., and might want to find more information about what he or she has read. Typically, the person copies the text of interest from the document that he or she is reading and pastes the text into the search box of a search engine. But when a person uses a search engine to find another document, it is likely that the person will be led away from the site that he or she was reading. The amount of revenue that a commercial web site can generate is often based on how much time users spend on that web site. So, when a user is reading site A and a search engine directs the user to site B, this action often represents lost revenue for the operator of site A. Even for web sites that do not generate revenue, there may be reasons to try to keep the user within the site. For example, a manufacturer might provide a web site that contains manual pages for a product. When a user is seeking help for the product through the manufacturer's site, the manufacturer might want to keep the user on that site for all questions about the product, since the manufacturer may believe that its own web site provides the most accurate information about its product. Even if the site owner does not want to direct the user to other pages in the site, the site owner might want to have some influence over what pages the user accesses when navigating away from the site owner's page.

Web pages often provide hyperlinks to other pages, and pages within the same site often link to each other. If a user is interested in a topic that has a link on the page that he or she is reading, the user will often follow the link rather than initiating a search through a search engine. However, many topics that a user might want to research are not associated with a hyperlink. The provider of the page could attach hyperlinks to all of the words and phrases in the page. However, an excessive number of hyperlinks can become distracting. Moreover, when a page is covered with links, a user may sense that the links were inserted haphazardly, and thus may assume that the links are of little value. Thus, a given web page typically has large amounts of text that are not associated with links. When some of this non-linked text catches the user's interest, the provider of the page is subject to the risk that a search engine will direct the user away from that provider's site.

### SUMMARY

Links may be provided on a web page in an unobtrusive manner. A web page may contains two types of links: links that are visible in the normal manner (e.g., through underlining, the use of different colors, etc.), and links that are only made apparent in response to some behavior by a user. In one example, the second type of links (“non-apparent links”) are made apparent when a user hovers over a word or phrase. When a user holds the mouse, for some number of seconds, over a word or phrase that has a non-apparent link, the link may be activated so as to make the link apparent to the user. The user then may click on the link and may be taken to the page that is referenced by the link.

In one example, the links that are activated by user behavior point to other pages on the same site, thereby reducing the chance that a user will navigate away from the site that contains the page that the user is currently viewing. In this sense, the techniques described herein may be used to deter a loss of site traffic. However, links could direct a user to any site, or could be used to execute a query on a search engine, or could perform any other action.

One way to implement the non-apparent links is through a script (e.g., a Java script) embedded in the page. The script may detect the hovering behavior, and may activate the appropriate link when the hovering behavior is detected. However, the activation of links may be implemented in any appropriate manner. Moreover, hovering is merely one type of behavior that could activate links. Other types of user behavior could also be used to activate the links.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example web page with different types of links.

FIG. 2 is a flow diagram of an example process of creating a document that has non-explicit links.

FIG. 3 is a flow diagram of an example process in which a user may interact with certain types of pages.

FIG. 4 is a block diagram of an example system in which content with non-explicit links may be generated and consumed.

FIG. 5 is a block diagram of example components that may be used in connection with implementations of the subject matter described herein.

### DETAILED DESCRIPTION

When users read documents on the web, they often read about areas that they would like to research further. While reading an article, a user might read about a person, a place, a scientific theory, a political development, etc., and might want to find additional information about what he or she has read. In some cases, the text relating to the topic that the person wants to research is highlighted by a hyperlink that the reader can follow. However, in many cases the user copies and pastes the text of interest into the search box of a search engine in order to find additional documents. Using a search engine in this way tends to direct the user away from the web site that he or she is already using.

The provider of a web site may have various reasons to keep the user on that provider's web site. Some of these reasons may be commercial—e.g., traffic on the provider's web site may generate revenue for the provider. However, there may be other reasons. For example, a product manufacturer might offer support through a web site. The manufacturer might not derive revenue directly from the use of its support site, but might want to encourage users to get support about the product through the manufacturer's web site rather than through other sites. Even if the web site provider does not seek to keep a user on its web site, it may want to influence the user's content experience in some way—e.g., by directing the user to specific third-party web sites. In general, if the user uses a search engine to find the next page to visit, then web site that the user is currently using has no control over what page the user views next. Including hyperlinks in a document encourages users to follow the links for further research rather than using a search engine. But including an excessive number of links in a document may be distracting, and may make the document less visually appealing. Also, including an excessive number of explicit hyperlinks on a page may create the perception, in the user's mind, that the links were not chosen carefully and thus are of little value.

The subject matter described herein provides techniques that give web site providers some influence over what web sites a user visits when the user navigates away from the page that the user is currently viewing. A web page may contain two types of links. One type of link is a normal hyperlink. Such hyperlinks typically appear in Hypertext Markup Language (HTML) web pages as underlined text that is in a different color from the rest of the text. In addition to this type of link, a web page may be infused with links whose existence is not readily apparent, but where the links can be activated, and thus made apparent, in response to user behavior. For example, certain words and phrases in a document might be associated with links. If a user hovers over one of these words or phrases for some defined amount of time (e.g., a particular number of seconds), the link is activated and appears to the user. The user can then click the link in order to go to the page referenced by the link. One way to implement these links is to include, in a page, a Java script (or other type of script) that detects the user's hovering behavior (or some other behavior), and that activates the links when the behavior is detected.

The links may be chosen in any manner. For example, prior to publication of a web page, the page may be analyzed to detect words and phrases in the page, and then a particular corpus of documents (e.g., the documents that make up a particular web site) may be examined to determine which pages within that site would be relevant to the detected words or phrases. The links may then be made to point to those pages. In one example, links are created for those words and phrases for which a relevant page exists in the same site as the referring page, thereby allowing a web site provider to encourage users to stay within that site. However, the links could point anywhere—e.g., the link could point to a third-party page, the link could invoke a search query on a search engine, etc.

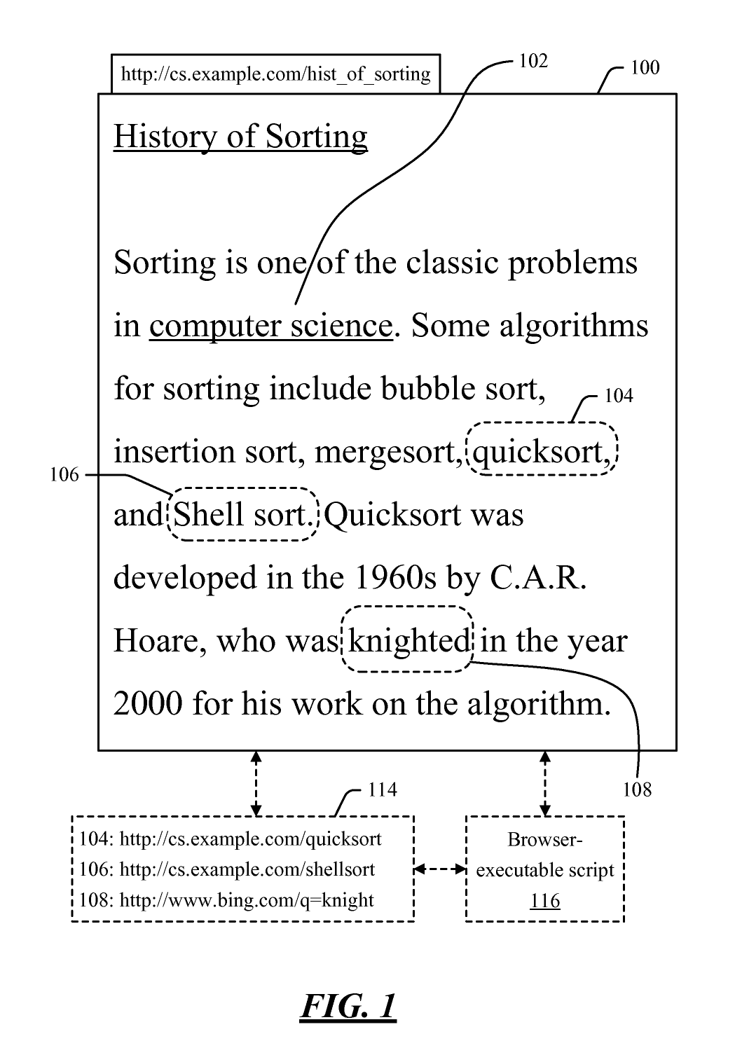

Turning now to the drawings, FIG. 1 shows an example of a web page 100 with various different types of links. In the example of FIG. 1, web page 100 contains text, although a web page could contain any type of content such as images, video, etc. Some of the text shown has explicit hyperlinks. For example, text 102 (the words “computer science”) is explicitly hyperlinked. If web page 100 is implemented in HTML code, then text 102 may be surrounded by “<a>” tags, where the “href” attribute of the <a> tag identifies a specific web page (e.g., an encyclopedia page on computer science), which a user would be taken to if he or she clicked on text 102. For text that is tagged in this manner, browsers are typically designed to display the text in a highlighted form (e.g., underlined, and in a color different from the rest of the text), and to issue a request for the link when the user clicks on the linked text. This type of link may be referred to as an explicit link. The link is explicit in the sense that the browser, upon initial load of the page, makes apparent to the user the fact that the text is linked (at least in the case where the user's browser handles an <a> tag in the normal manner).

In addition to explicitly linked text 102, web page 100 also contains several non-explicit links. The non-explicit links may not be apparent to the user, since they might not be highlighted during normal viewing of web page 100. That is, when web page 100 is first loaded and rendered, the text associated with non-explicit links may appear in normal writing (e.g., without underlining, or without being colored differently from the rest of the text). However, in response to some form of behavior in which the user has engaged, the non-explicit links may become activated, thereby allowing the user to follow the links as if they were explicit links. In FIG. 1, sections of text 104, 106, and 108 are non-explicit links. When web page 100 is first rendered, these links appear like non-linked text. However, sections of text 104, 106, and 108 may be associated with specific links, which may be made apparent to the user in response to some form of behavior. The subject matter herein is not limited to any particular form of behavior to activate the link, but in one example the link is activated when the user hovers over the linked text for some defined amount of time, such as a pre-determined number of seconds. For example, if the user hovers over text 104 for more than two seconds, that text may become underlined and may change color, thereby making it appear in the same manner as an explicit link would have been rendered. If the user clicks the text, the user may be taken to the site that is linked to that text. The act of making the text appear like an explicit hyperlink (or otherwise making the existence of the link apparent in some manner) may be referred to herein as activating a non-explicit or non-apparent link. While hovering over the linked text is one example of a user behavior that could activate such a link, other types of user behavior could also be used to activate the link.

Data to represent the non-explicit links may be stored in page 100. For example, data 114 contains the Uniform Resource Locators (“URLs”) that are associated with sections of text 104, 106, and 108. Code may be included in page 100 (e.g., browser-executable script 116, which could be Java script, HTLM 5 script, or any other type of script) that detects the user behavior that triggers activation of a link, and that retrieves the appropriate URL from data 114. Thus, if a user hovers over text 104 for a sufficient period of time, script 116 would detect that the link associated with text 104 has been activated. That code would then use data 114 to identify the link associated with text 104 (“http://cs.example.com/quicksort), and would then activate the link by making text 104 appears like an ordinary hyperlink. The user could then click on the link in box 110. (It is noted that the link might be made to appear as an ordinary hyperlink, but might not be implemented in the same way. For example, explicit hyperlinks might be implemented with <a> tags that can be processed directly by a browser's HTML engine, while non-explicit hyperlinks might not be implemented using <a> tags. Thus, the code that implements the non-explicit links—e.g., script 116—may also intercept clicks on the activated links in order to perform the appropriate action in response to clicks on those links.)

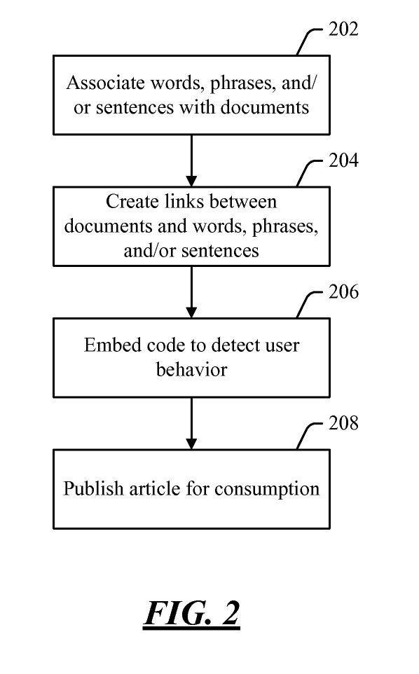

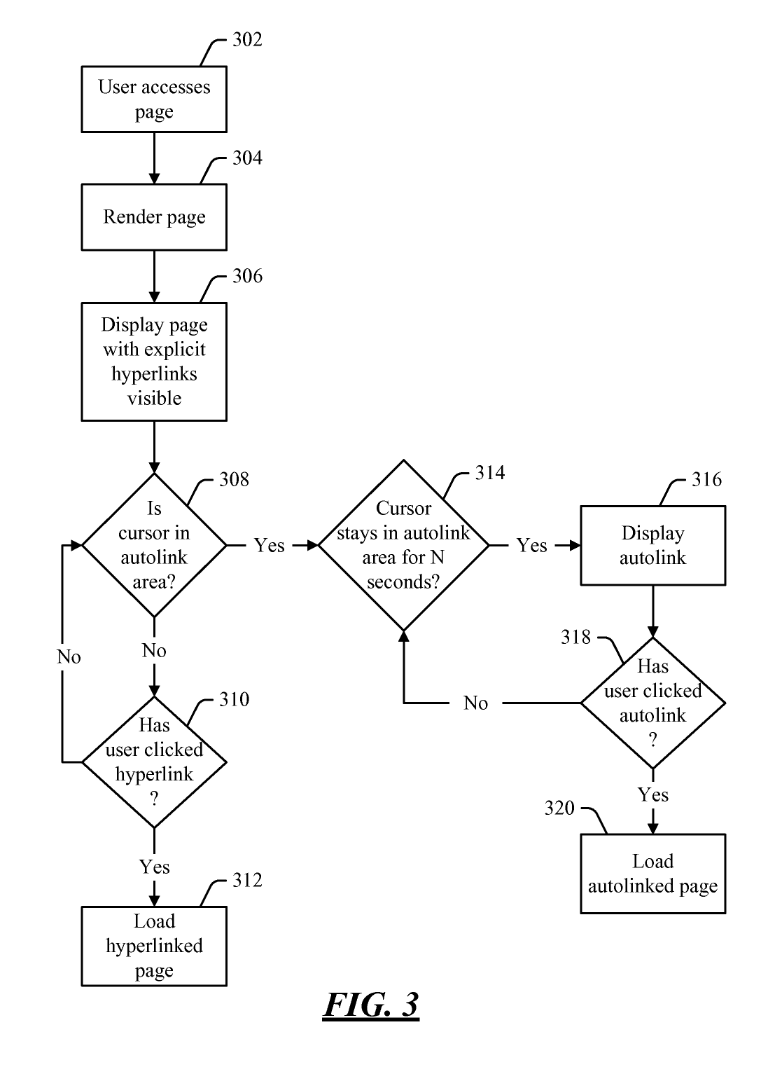

FIG. 2 shows an example process of creating a document that has non-explicit links. Before turning to a description of FIG. 2, it is noted that the flow diagrams contained herein (both in FIG. 2 and in FIG. 3) are described, by way of example, with reference to components shown in FIG. 1, although these processes may be carried out in any system and are not limited to the scenario shown in FIG. 1. Additionally, each of the flow diagrams in FIGS. 2 and 3 shows an example in which stages of a process are carried out in a particular order, as indicated by the lines connecting the blocks, but the various stages shown in these diagrams can be performed in any order, or in any combination or sub-combination.

At 202, the article is examined in order to associate various words and phrases in an article with other documents. For example, if the phrase “Shell sort” appears in the document to be published, it may be determined that the article located at http://cs.example.com/shellsort is particularly relevant to that phrase. This determination may be made by a human editor, through algorithmic search techniques, or through any other appropriate mechanism.

At 204, a link is created between the phrase and the document. As described above in connection with FIG. 1, this link may be a non-explicit or non-apparent link, in the sense that the presence of this link is not initially displayed to a user, but rather appears in response to some user action. The link may be embedded in the document in an appropriate manner—e.g., in the form of non-printing data, such as data 114 shown in FIG. 1.

As noted above, one aspect of choosing links to words or phrases in a document is that the links can be chosen in a manner that tends to keep users on a single multi-page web site. For example, if page 100 on the history of sorting (shown in FIG. 1) is part of the site cs.example.com, and if there is a distinct page on the quicksort algorithm that is part of the cs.example.com site (e.g., some page on the cs.example.com web site that is distinct from page 100 in the sense that it is not the same page as page 100), then the link associated with the word quicksort can be a link to a page on the same site. Thus, if a user is interested in quicksort, the non-explicit link can be used to encourage the user to remain on the cs.example.com web site rather than going to another web site (as the user might have done if he had entered “quicksort” into a search engine, since the engine might have pointed the user to a relevant page on another site). However, it is noted that non-explicit links are not limited to the case where the links point to pages on the same site as the referring page. Rather, a link may point to any document.

At 206, code may be embedded in the page, where the code detects the user behavior that activates the links. For example, a Java script may be added to the page, where the Java script may detect whether the user has hovered over a particular word or phrase for a sufficient amount of time, and causes a non-explicit link to be displayed if hovering has occurred for that amount of time.

At 208, the page—including its embedded code and non-existent links—may be published for consumption. In one example, the page is published so as to be accessible to the public on the Internet, although the page could be published in any manner.

After a page has been published, it may be accessed by a user, and the user may interact with the page. FIG. 3 shows an example process in which a user may interact with a page that contains non-explicit links. At 302, a user accesses the page. For example, the user may request the page through the user's browser (e.g., by entering the URL of the page into the navigation bar, or by following a link to the page). As noted above, the page may contain Java script code as a way of implementing non-explicit links (although the non-explicit links could be implemented in some other manner). After the page has been loaded by the browser, at 304 the page is rendered. The browser then displays the page with explicit hyperlinks visible (at 306). For example, the browser's HTML rendering engine may process “<a>” tags in the HTML code in the normal manner, in which the text associated with such links is displayed in a different color from other text, and is also underlined.

As the user interacts with the page, the code that is used to implement the non-explicit links determines whether to activate the links. This determination typically involves determining whether a particular user behavior has occurred with respect to the page or with respect to the links. However, one example way of determining whether to activate the links is described below. At 308, it is determined whether the cursor (e.g., the arrow cursor controlled by the mouse or other pointing device) is in an autolink area. (The areas that are enclosed by dotted lines in FIG. 1 to surround text 104, 106, and 108 are each examples of “autolink areas.”) If the cursor is not in an autolink area, then it is determined (at 310) whether the user is clicking an explicit hyperlink. The determination as to whether the user is clicking an explicit hyperlink may not involve the Java script, since the processing of an explicit hyperlink (e.g., an “<a>” tag) can be handled by the normal HTML engine in the browser. If the user is not clicking a hyperlink, then the process cycles back to 308 to determine whether the cursor is in an autolink area. In effect, the cycle between 308 and 310 amounts to waiting for the user to take some action—whether that action is clicking an explicit hyperlink, or putting the cursor into an autolink area. If, during this waiting process the user does click on an explicit hyperlink, then the user is taken to the page referenced by the hyperlink—e.g., that page may be loaded into the current browser window and/or tab, or into a new window and/or tab (at 312).

If it had been determined at 308 that the cursor is in the autolink area, then it may be determined (at 314) whether the cursor remains in that area for some defined amount of time such as N seconds, where N is a number such as two. If the cursor does remain in the autolink area for N seconds, then, based on that determination, the autolink may be displayed in some manner (at 316). For example, the autolink may be displayed as if it were a hyperlink—e.g., by underlining the text associated with the autolink and/or making the color of that text different from the color of other text in the document. Or, a separate user interface such as a box containing the link may be displayed to the user. If the user clicks in the autolink area (as determined at 318), then the user may be taken to the page referenced by the link—e.g., by loading that page into the current browser window and/or tab, or into a new window and/or tab (at 320).

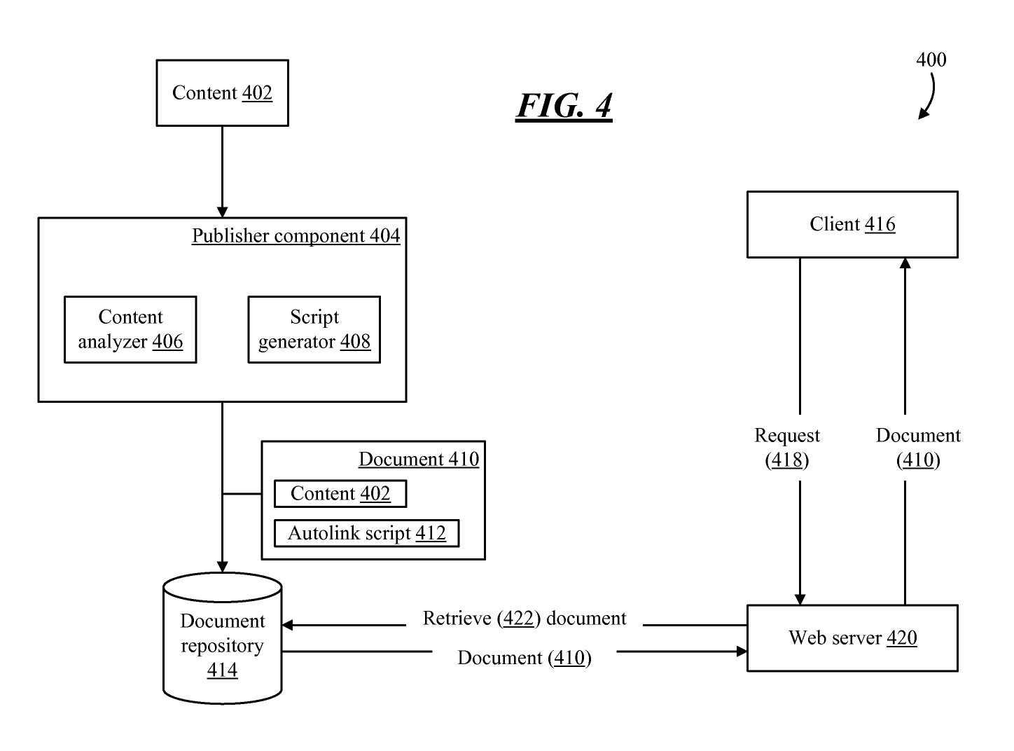

FIG. 4 shows an example system 400 in which content with non-explicit links may be generated and consumed. In system 400, content 402 is received by a publisher component 404. For example, content 402 may be an HTML document containing text, images, etc. Publisher component 404 may comprise a content analyzer 406 and a script generator 408. Content analyzer 406 may analyze content 402 to determine what non-explicit links to add to the content. For example, content 402 could be the web page 100 shown in the example of FIG. 1. In that case, content analyzer 406 may determine that the text “computer science” is already hyperlinked (e.g., perhaps to a third part encyclopedia on computer science) and thus can be passed through to the published document. However, content analyzer 406 may determine that words and phrases that are not already hyperlinked—such as “quicksort” and “Shell sort”—can be associated with links. For example, the provider of web page 100 might determine that it has additional pages that cover the topics of quicksort, and Shell sort, and that those pages can be included as non-explicit links in web page 100. Or, content analyzer may simply add links related to these words and phrases even if the provider of web page 100 does not offer any specific content on these topics. E.g., content analyzer might simply create links that are actually search queries for the words and phrases, such as “search.example.com/q=knight”. Content analyzer 406 does not have to associate a link with every word or phrase that appears in content 402, and thus content analyzer 406 may perform both the acts of selecting which words and/or phrases to associate with non-explicit links, and also determining which links to associate with those words and/or phrases.

Script generator 408 adds a script to content 402 that implements the non-explicit links. For example, script generator 408 may add a Java script that detects the user behavior that activates a link. Additionally, script generator 408 may add, to the page, the code and/or data that associates a given text segment with a particular non-explicit link. For example, a Java script to be included in a web page may include one or more data fields that identify the locations of the various autolink areas, and that also identify the URLs that are pointed to by the autolink areas. For example, data 114 (shown in FIG. 1) is an example of data field(s) that script generator 408 could include in the Java script.

After publisher component 404 evaluates content 402 and adds the appropriate script (e.g., by using content analyzer 406 and script generator 408 in the manner described above), publisher component 404 generates document 410, which comprises content 402 plus an autolink script 412, where autolink script 412 contains the non-explicit links, and also detects the behavior that activates the non-explicit links. Document 410 may be stored in document repository 414. It is noted that the non-explicit links in a document may be changed after document 410 is added to document repository. For example, the links in document 410 may be updated regularly in order to ensure that the links are fresh. As another example, another way to keep the links fresh is to add a level of indirection to the links. For example, if the link is to point to an article on Shell sort, it could point to http://contentserver.example.com/shellsort. The actual article might be stored somewhere else (e.g., at http://cs.example.com/shellsort, as in the earlier example), but contentserver.example.com may know what the current article on Shell sort is, and can redirect to that article. That way, if the location of the article changes, contentserver.example.com can redirect a request to the new location, so that if a user follows an autolink the link will direct the user to a place that has current, relevant content.

At some point, client 416 requests document 410. For example, client 416 may be a browser on a user's computer, and client 416 may request document 410 as a result of the user's having entered the URL of document 410 into the browser's navigation bar. Thus, client 416 issues request 418 for document 410 to web server 420. Web server 420 then retrieves (422) document 410 from document repository 414. Document repository 414 then provides document 410 to web server 420, which serves document 410 to client 416.

Once the document is on client 416, it may be displayed to the user, and the process of FIG. 3 may then occur with respect to that document.

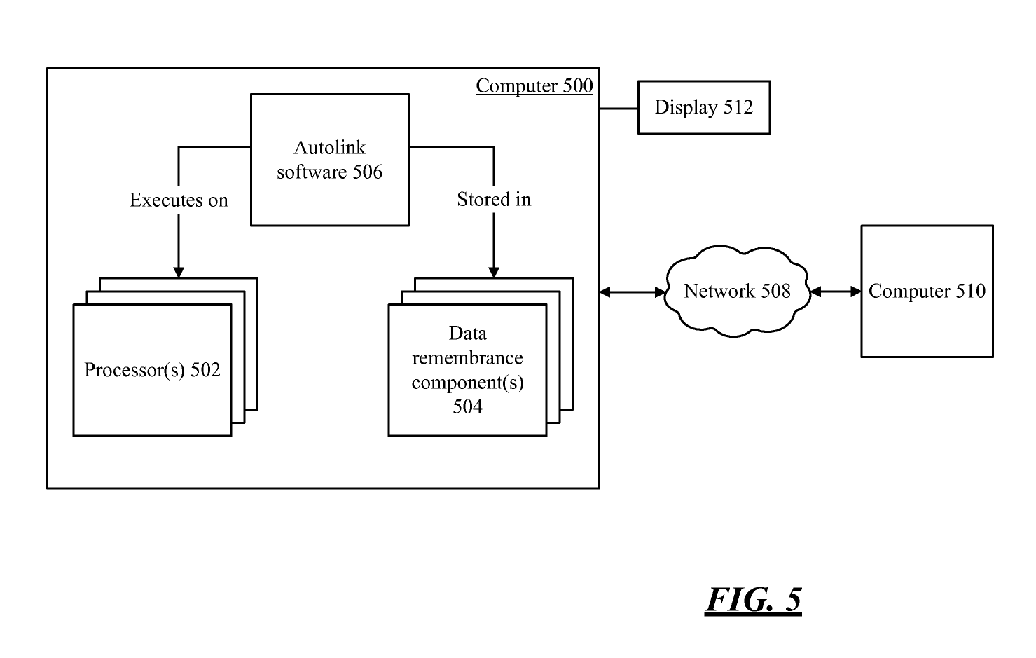

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is autolink software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more non-transitory computer-readable media that store instructions to provide links to a user, wherein the instructions, when executed by a computer, cause the computer to perform acts comprising:
detecting that a user who is interacting with a first web page that comprises the instructions has engaged in a behavior with respect to the first web page;
based on said detecting, identifying a link associated with a word or phrase that has been indicated by said user;
displaying said link, wherein said link is not displayed prior to said detecting;
determining that said user has requested to follow said link;
issuing a request for a second web page identified in said link; and
displaying said second web page.

2. The one or more non-transitory computer-readable media of claim 1, wherein an area is defined in which said word or phrase is located, and wherein said detecting comprises:
detecting that a cursor has hovered in said area for a defined amount of time.

3. The one or more non-transitory computer-readable media of claim 1, wherein hyperlinks on said first web page are displayed in a manner, and wherein said displaying of said link comprises showing said link in said manner.

4. The one or more non-transitory computer-readable media of claim 3, wherein said manner comprises underlining hyperlinked text and displaying the hyperlinked text in a color that is different from other text in said first web page, and wherein said word or phrase, at a time that said first web page is initially loaded, is not underlined and is not shown in said color, and wherein said displaying of said link comprises:
showing said word or phrase in said color; and
underlining said word or phrase.

5. The one or more non-transitory computer-readable media of claim 1, wherein said first web page and said second web page are both part of a single web site.

6. The one or more non-transitory computer-readable media of claim 1, wherein said first web page is part of a web site, and wherein said link comprises a query derived from said word or phrase.

7. The one or more non-transitory computer-readable media of claim 1, wherein said instructions comprise browser-executable script that is embedded in said first web page.

8. The one or more non-transitory computer-readable media of claim 1, wherein said page comprises explicit links and non-explicit links, said link being an explicit link but not a non-explicit link.

9. A method of providing links in content, the method comprising:
using a processor to perform acts comprising:
receiving the content;
analyzing the content to identify words or phrases in the content with which to associate links;
associating a link with the words or phrases that are identified by said analyzing;
including, in a document, data that comprises:
said content; and
code that detects whether a user behavior has occurred with respect to said document and that, in response to determining that said user behavior has occurred, displays a first link associated with one of the words or phrases that are identified by said analyzing, wherein said first link is not displayed before said user behavior is detected; and
storing said document in a document repository.

10. The method of claim 9, said one of said words or phrases appears in an area of said document, and wherein said user behavior that is detected by said code comprises:
determining that a cursor has hovered in said area for a defined amount of time.

11. The method of claim 9, wherein hyperlinks in said document are shown in a manner, wherein said first link is not displayed in said manner at a time that said document is initially displayed, and wherein code that displays said first link shows said first link in said manner.

12. The method of claim 9, wherein said document is a first web page that is part of a web site, and wherein said first link points to a second web page that is distinct from said first web page and that is part of said web site.

13. The method of claim 9, wherein said document is a first web page that is part of a web site, and wherein said first link comprises a query that is derived from said one of the words or phrases and that is executed by a search engine that is not part of said web site.

14. The method of claim 9, wherein said code comprises browser-executable script.

15. The method of claim 9, wherein said content comprises explicit links, and wherein links associated with said words or phrases are non-explicit links that are included in said document with said explicit links.

16. A system to create a page that includes explicit links and non-explicit links, the system comprising:
a processor;
a data remembrance component;
a publisher that executes on said processor and that is stored in said data remembrance component, that receives content that comprises text and an explicit link, and that associates words or phrases in said content with links to pages, wherein said words or phrases are not associated with any explicit link in said content, wherein said publisher creates a document that comprises:
said content;
data that indicates which of said links are associated with which of said words or phrases; and
a script that detects when a user behavior has occurred with respect to one of said words or phrases, wherein said script causes a link associated with said one of said words or phrases to be displayed when said user behavior is detected with respect to said one of said words or phrases; and
a document repository that receives said document from said publisher and stores said document.

17. The system of claim 16, wherein said one of said words or phrases is located in an area of said document, and wherein said user behavior that is detected by said script comprises a cursor hovering in said area for a defined amount of time.

18. The system of claim 16, wherein said explicit link is displayed in a manner that comprises:
underlining first text associated with said explicit link; and
showing said first text in a different color from other text in said document; wherein said non-explicit links are not displayed in said manner when said document is initially loaded, and wherein said script causes said one of said words or phrases to be displayed in said manner in response to detecting of said user behavior.

19. The system of claim 16, wherein said document is a first web page that is part of a web site, and wherein said link associated with said one of said words or phrases is a link to a second page that is distinct from said first web page and that is part of said web site.

20. The system of claim 16, wherein said script comprises a Java script that is embedded in said document.
